(19) United States
(12) Patent Application Publication
(10) Pub. No.: US 2026/0336893 A1
(43) Pub. Date: Oct. 29, 2026

(54) REUSABLE GIFT-WRAPPING SYSTEM WITH SENSORY FEEDBACK

(71) Applicant: Natalie Brynn King, Ashburn, VA (US)

(72) Inventor: Natalie Brynn King, Ashburn, VA (US)

(21) Appl. No.: 19/658,149

(22) Filed: Apr. 24, 2026

Related U.S. Application Data
(60) Provisional application No. 63/794,103, filed on Apr. 24, 2025.

(51) Int. Cl. B65D 65/22; B65D 65/08

(52) U.S. Cl. CPC B65D 65/22; B65D 65/08

(57) ABSTRACT

A reusable wrap apparatus to enclose an object and provide a sensory experience to a user in response to mechanical manipulation of the apparatus is provided. The wrap apparatus includes a pliable sheet to receive and enclose the object in an enclosed state, a releasable connector coupled to the sheet, and designed to attach to a portion of the sheet around the object in the enclosed state and to detach from the portion of the sheet in an opened state to permit removal of the object from the sheet, and a sensory feedback feature coupled to the sheet. The sensory feedback feature provides an audible feedback or tactile feedback to the user, in response to mechanical manipulation of the sheet or detachment of the releasable connector from the portion of the sheet during a release from the enclosed state.

### CROSS-REFERENCE TO RELATED APPLICATIONS

This application claims the benefit under 35 U.S.C. § 119(e) of the filing date of U.S. Patent Application No. 63/794,103, for REUSABLE GIFT WRAP, which was filed on Apr. 24, 2025, and which is incorporated here by reference.

### BACKGROUND OF THE INVENTION

Embodiments of the invention generally relate to reusable gift-wrapping systems, and more particularly to reusable wrapping structures configured to simulate the sensory experience of opening traditional paper gift wrap.

There is an estimated 2.6 billion pounds of wrapping paper thrown away in the United States every year. Most wrapping paper is coated in material that prevents it from being able to be recycled. The waste from wrapping paper slowly lets off harmful gases into the atmosphere over time. Some more traditional gift-wrapping options can be reused, such as gift bags, but these may still end up being thrown away after being used a handful of times.

There are diverse reusable gift wrapping options in the United States, but these options have not caught on in significant numbers. With the continuous amount of waste that classic wrapping paper creates, there is need in the marketplace for improvements and more reusable options that will be adopted in larger numbers to create more sustainable results.

Although it is widely known how wasteful wrapping paper is, there are many reasons that wrapping paper use continues and has become an integral part of culture and tradition. Wrapping paper is a simple and affordable way to make gifts look more appealing, to conceal what is inside, and to provide a fun experience when opening the gifts. Adults and children are rarely encouraged and given the opportunity to destroy something in a socially acceptable manner. Wrapping paper is unique in offering this experience. The tactile feel and audible experience associated with ripping or tearing open a paper-wrapped gift are fun, interactive, and so physically memorable for our senses that people repeatedly enjoy these activities, keeping wrapping paper a central part of gift-giving cultural traditions and perpetuating the problem of creating more waste.

Traditional wrapping paper is heavily relied on for gift giving holidays and other special occasions. Wrapping paper is printed with aesthetically pleasing designs making gifts look more enticing while concealing the contents and delivering a fun gift opening experience. Gift bags are frequently used in the same manner, especially for convenience and for short-term reusability. Gift bags may easily rip, get stained, become ruined if wet, or wrinkle after being used a few times.

While traditional wrapping paper options offer many aesthetic and fun elements, they are also wasteful as most options are made from materials designed for one time use. Once wrapping paper is used, new paper must be purchased for future needs. Many resources are wasted in producing, distributing, and purchasing a product meant to go into the trash.

There have been many attempts in developing reusable options, but nothing has captured a noticeable piece of the market in the United States. There are many different styles of reusable gift wrapping in the prior art. For example, there is a general style of wrapping called furoshiki common in Japan that is a piece of fabric cloth designed to wrap gifts or items for transport. There are various other types of fabric sheets used to wrap gifts inside with various fastening closures, that more closely resemble a classically wrapped gift.

U.S. Patent Application Publication 2022/0073245 A1 describes a double-sided-stretchable fabric sheet partially made from recycled plastic that gifts of various sizes and shapes can be folded up inside and tied to itself making a simple bow.

U.S. Patent Application Publication 2021/0130054 describes a reusable gift wrap fabric sheet with male and female fasteners on either the interior or exterior. Gifts can be folded and wrapped into the sheet and male and female fasteners along all edges of the sheet can be connected together to hold wrapping in place.

U.S. Patent Application Publication 2021/0171258 describes a reusable fabric gift wrap sheet that is double-sided with a built-in elastic loop for a quick fastening option and a sizing strip for the ability to adjust the wrap based on the size of gift being wrapped.

U.S. Patent Application Publication 2012/0145291 describes a reusable fabric gift wrap sheet with a built-in fastener where a gift is folded inside the sheet and fastened by three corners of the wrap coming together and pulled through a soft rubber opening near the fourth corner.

U.S. Patent Application Publication 2012/0012646 describes a reusable fabric sheet based wrapping system with various fastening options such as magnets, hook and loop patches, removal bands and buttons with a special record keeping element to track who the gift wrap was given to last. This art includes several different embodiments including an embodiment making the fabric sheet based on 6″ squares with hook and loop edges that can be put together or taken apart to make larger or small pieces of fabric sheets for wrapping.

U.S. Patent Application Publication 2010/0127052 describes a reusable fabric piece that has a rectangular-shaped center with four separate panels that stick out that can be folded over a gift and tied to itself for fastening.

U.S. Pat. No. 5,904,289 describes a reusable fabric sheet that gifts can be wrapped in, and is slightly adjustable based on the size of the gift by being sealed through use of various types of fasteners, including hook and loop, snaps, eyelet and loop, or double-sided tape lined along the edges of the fabric.

U.S. Pat. No. 5,979,744 describes a fabric sheet-based gift wrap with two pieces of wrapping used to fold a gift inside and fasten the gift with a hook and loop and a ring to hold wrapping closed. Alternate options have a spot for gifts to slide into a pocket and to be folded up and fastened closed.

U.S. Pat. No. 5,392,983 A describes a reusable fabric sheet that gifts can be folded and wrapped inside and fastened by a resealable adhesive coating.

U.S. Pat. No. 5,004,144 A describes a reusable fabric sheet with four distinctive panels that can be folded over a gift and fastened with hook and loop fasteners.

Further, there are various types of sleeves, tubes, and pouch-styled reusable gift wrap that can tuck a gift into a pocket, sleeve or pouch, and the rest of the wrapping can be fastened at the openings, wrapped around, and tied or fastened to enclose the gift.

U.S. Pat. No. 9,174,783 and U.S. Patent D792,238 disclose a reusable gift wrap made of two separate fabric sleeves where a gift box can slide into one of the sleeves, and then the second sleeve can slide over the remained exposed half of the gift box and brought together at the center to fasten and conceal a gift box.

U.S. Patent Application Publication 2019/0308777 describes a stretchable fabric tube open at each end that a gift can slide inside, where the two open ends are then pulled up and tied in a knot to seal the gift inside.

U.S. Patent Application Publication 2004/0026488 describes a reusable stretch fabric gift wrap where gifts are tucked into a pocket, folded up in the fabric wrap, and fastened with an attached ribbon tied closed.

U.S. Pat. No. 8,931,242 describes a reusable stretchable tube-like gift wrap system with a specific bottom and top. The bottom portion is sealed closed, and gifts are slid through the opening on top. A closure plate slides over the top opening which pulls the loose fabric through and fastens the gift closed.

U.S. Patent Application Publication 2009/0152332 describes a reusable pouch with an opening at each end that a gift can slide into, cinch to the closed position, and be tied with a drawstring-style element.

U.S. Patent Application Publication 2012/0308163 describes a reusable fabric gift wrap that has a drawstring cord disposed around the outer edge of the wrap that can tighten to enclose a gift inside.

U.S. Pat. No. 5,934,548 describes a reusable gift wrap that is an expandable flexible sleeve with an open end on each side that a box can slide into. Each end is fastened by being folded over and held with a fastening tab. An attached ribbon is wrapped and tied around the gift.

Further, it is known that decorative containers can conceal gifts in an attractive manner and be reused for a longer amount of time if taken care of.

U.S. Pat. No. 5,183,199 A describes a container with wall panels that can be folded up, so that gifts can be slid into a sleeve-like opening on either side of the container. Flaps are folded over at the corresponding two ends over the interior space of the container, so that gifts are concealed inside.

In the field, the continued efforts to develop more convenient and environmentally friendly gift-wrapping options have made some progress, as evidenced by the increasing number of reusable options, but these reusable options neglect to address one missing element. None of these options offer the audible and tactile feeling that is strongly associated with opening gifts. Offering a product that delivers convenience, reusability, and that mimics the audible and tactile gift opening experience traditionally present with classic wrapping paper will encourage larger portions of the market to consider switching to a reusable product.

In view of the foregoing, there is a need for a reusable gift-wrapping system and/or apparatus which solves the aforementioned deficiencies in the state of the art.

### SUMMARY OF THE INVENTION

In one embodiment of the invention, a reusable wrap apparatus for use to enclose an object and provide a sensory experience to a user in response to mechanical manipulation of the apparatus relative to the object is provided. The wrap apparatus comprises a pliable sheet configured to receive and enclose the object in an enclosed state, a releasable connector detachably coupled to the sheet, and configured to attach to a portion of the sheet around the object in the enclosed state, and to detach from the portion of the sheet in an opened state to permit removal of the object from the sheet, and a sensory feedback feature coupled to the sheet. The sensory feedback feature provides an audible feedback or tactile feedback to the user, in response to mechanical manipulation of the sheet or detachment of the releasable connector from the portion of the sheet during a release from the enclosed state.

In one embodiment of the invention, the pliable sheet is formed by a pair of segments with a corresponding pair of edges that is detachably coupled together along a seam. The releasable connector extends along at least one of the corresponding pair of edges of the pair of segments. In one embodiment, the sensory feedback feature comprises a pair of sensory feedback layers that is coupled to the corresponding pair of segments and extends along the seam of the pliable sheet, and each of the pair of sensory feedback layers is positioned adjacent to or in proximity to the releasable connector.

In certain embodiments of the invention, a reusable sheet comprises a one-piece sheet or multiple segments configured to enclose an object inside. A sheet with multiple segments is secured together by one or more releasable connector features positioned to form a releasable interface between adjacent segments of the sheet to permit controlled opening of the wrapping configuration. The segments are connected to form a larger sheet used to fold and enclose gifts. Gifts are wrapped inside the sheet along the releasable connector feature, which is positioned adjacent to a sensory-feedback feature, which can be a sensory-feedback layer. Gifts wrapped inside the reusable sheet produce an audible sound when the wrapping is moved or manipulated through touch, similar to the sound of a gift wrapped in wrapping paper or tissue paper. The sheet can be opened along the releasable connector feature to remove a gift from inside, and the segments can be reconnected along the releasable connector feature for repeated use.

The use of a sensory-feedback feature or layer within the sheet positioned adjacent to a releasable connecting feature is configured to structurally generate audible and tactile paper or tearing-like feedback when the sheet is opened along the releasable connecting feature, mimicking the feel and sound associated with opening paper-wrapped gifts.

In view of the foregoing embodiments, a reusable wrapping system and apparatus are engineered to replicate the interactive, tactile, and auditory experience of opening a gift wrapped in paper. The reusable wrapping system and apparatus require a comparable amount of physical tension and pull to open the sheet along the releasable connector feature, similar to a gift wrapped in paper, and thus provide an audible, interactive, and tactile gift-opening experience. The system and apparatus simulate the sensory experience of tearing wrapping paper through coordinated interaction between a sensory-feedback feature or layer, a calibrated releasable connector feature, and a structural configuration that directs opening forces away from structural seams.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

The following images display an exemplary embodiment of the invention only and are not meant to be limiting.

FIG. 1 depicts a view of two separate exterior segments of fabric. The separate segments are identical to each other with one segment having a releasable connector feature along the diagonal edge of the segment.

FIG. 2 depicts a view of the interior of two separate segments of fabric, one segment showing a releasable connector feature along the diagonal edge. The outline of the casing containing an interior sensory-feedback feature or layer can be seen along the diagonal edges of each segment.

FIG. 3 depicts the exterior of a fabric sheet with all segments attached together which is used to wrap gifts inside.

FIG. 4 depicts the interior of the fabric sheet with all segments attached together. The outline of the casing containing the sensory-feedback feature or layer can be seen along the diagonal seam of the fabric sheet.

FIG. 5 depicts an alternate embodiment of a fabric sheet being double-sided with two layers of fabric and a different print on each side.

FIG. 6A depicts the first step in wrapping a box in the fabric sheet.

FIG. 6B depicts the second step in wrapping a box in the fabric sheet.

FIG. 6C depicts the third step in wrapping a box in the fabric sheet.

FIG. 6D depicts the fourth step in wrapping a box in the fabric sheet.

FIG. 6E depicts the fifth and final step in wrapping a box in the fabric sheet.

FIG. 6F depicts the side view of a box wrapped in the fabric sheet.

FIG. 7A depicts an elastic band that can be used to tie the fabric sheet ends together to enclose a gift.

FIG. 7B depicts a view of an alternative embodiment where the fabric sheet ties the two loose sides together with an elastic band, decorative elastic member, other stretchy band item, or separate tie forming a large bow on top.

FIG. 8 depicts the location of the opening path on the bottom of a wrapped gift where a seam can be opened using the releasable connector feature.

FIG. 9 depicts a view of the sheet after the releasable connector feature has been completely opened after a gift has been removed.

FIG. 10 depicts a view of an alternate embodiment that includes an opening tab on the underside of a wrapped gift as an indicator to easily identify the location where the user begins opening a gift.

Like reference numbers and designations in the various drawings indicate like elements.

### DETAILED DESCRIPTION OF CERTAIN EMBODIMENTS

Embodiments of the present invention provides a reusable gift-wrapping system and apparatus that replicate the audible, tactile, and interactive experience of opening a gift wrapped in paper while enabling repeated use. The system and apparatus preserve the sensory qualities of traditional gift wrapping and reduces waste associated with single-use paper.

In one embodiment of the invention, the reusable gift-wrapping system is accomplished through use of unique patterns that enable a user to wrap a gift in an aesthetically pleasing way while incorporating seams and releasable connector features that can be separated at a comparable location to where gifts wrapped in paper have a seam and are opened. The patterns incorporate a coordinated structural sensory system to replicate the feel and sound of traditional wrapping paper being held and opened while remaining reusable. A sensory-feedback feature or layer is positioned relative to a releasable connector feature such that manipulation and separation of the releasable connector feature induces movement of the sensory-feedback feature or layer, thereby generating audible paper-like feedback, while the releasable connector feature provides calibrated separation resistance and cooperates with the sensory-feedback feature or layer, such that one or both components generate audible feedback during release. The patterns incorporate a structural configuration that directs opening forces away from seam failure, allowing gifts to be yanked or pulled open at the releasable connector feature, and ensuring gift wrap reusability. The sensory-feedback feature or layer is configured to generate audible paper-like feedback in response to mechanical deformation, such that incidental handling or manipulation of a wrapped gift may produce audible feedback, simulating paper-based wrapping prior to opening the releasable connector feature and enhancing the sensory experience associated with gift anticipation and presentation.

In one embodiment of the invention, the reusable gift-wrapping system is implemented using two or more fabric segments 14, each configured to connect with other segments 14 using a releasable connector feature 12. When joined along the releasable connector feature 12, the segments form a larger sheet 11 configured to wrap and enclose a gift or other object. The segments are secured together at one or more releasable connector feature(s) 12 positioned to form a controlled separation interface, permitting controlled opening of the assembled sheet 11. In one embodiment, the releasable connector feature 12 provides calibrated separation resistance while enabling repeated opening and reconnection of the sheet 11.

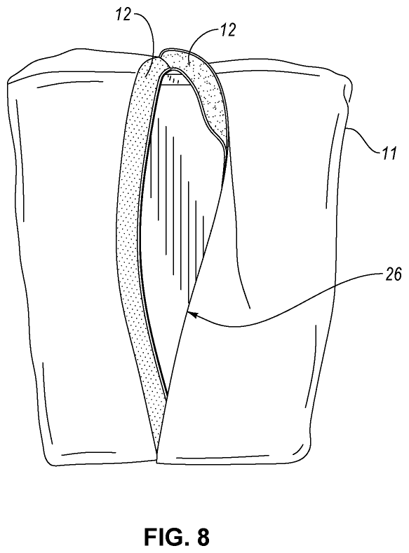

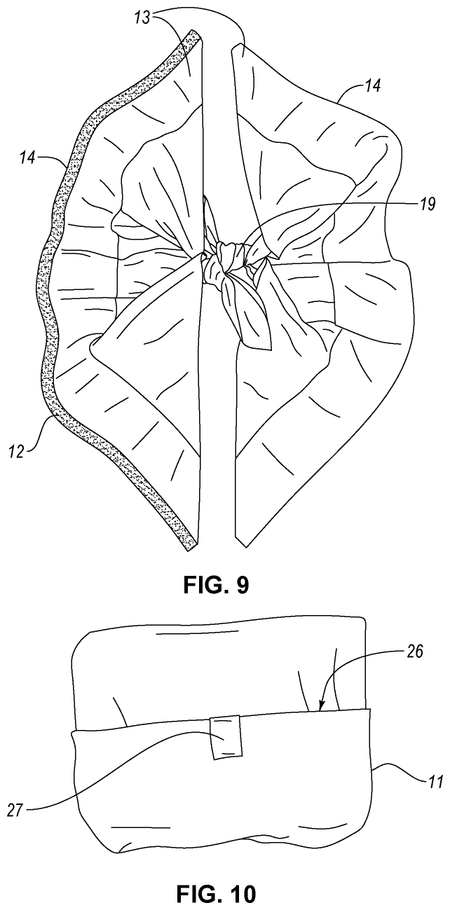

The shape of the sheet 11 with all segments 14 connected is a square or any other shape, and can be various sizes as needed to fit dimensions of small items up to extra-large items. In one embodiment, the sheet 11 is comprised of two or more segments 14 of equal or various sizes, and each segment includes one or more of the releasable connecting features 12 coupled thereto. Segments 14 can be triangular, rectangular or any shape or size to fit the needs of the pattern. The segmented pattern configuration directs opening forces toward the releasable connector feature 12, while reducing stress concentration at structural seams, thereby allowing a wrapped item to be opened completely through forceful pulling or tearing motions, without damaging the reusable wrap as shown in FIGS. 8 and 9.

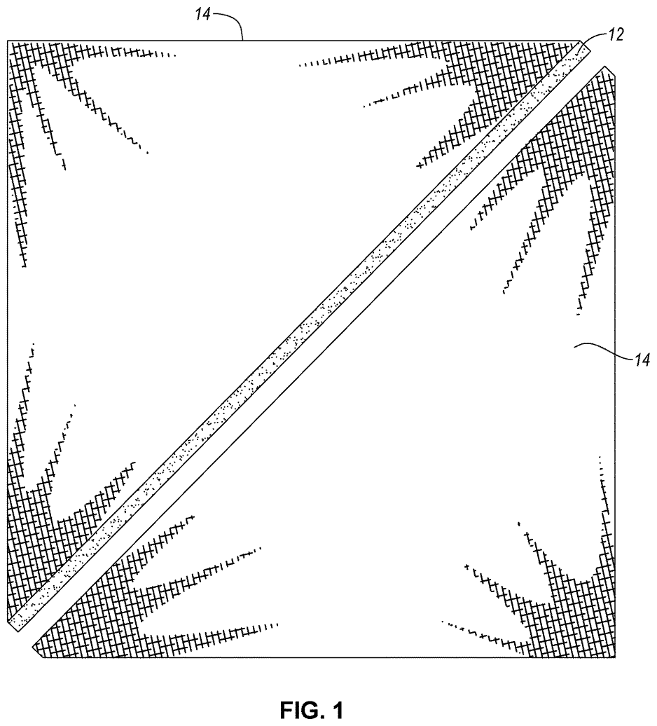

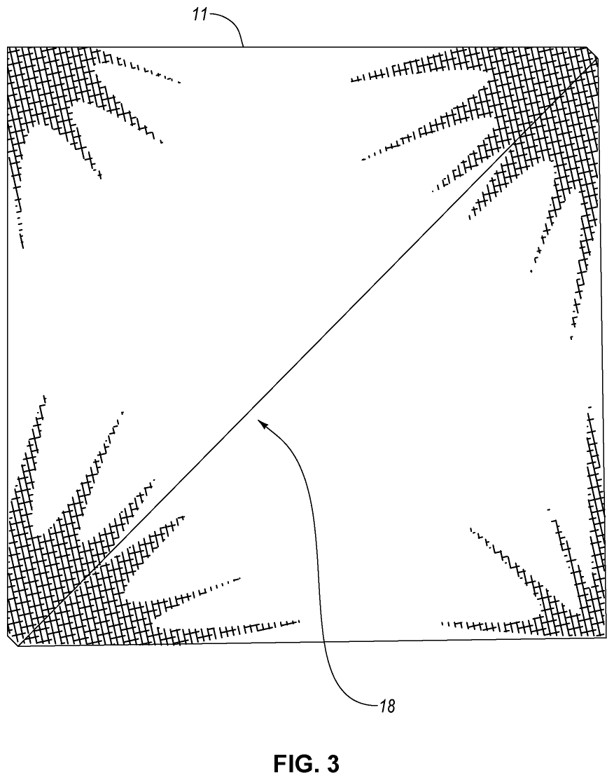

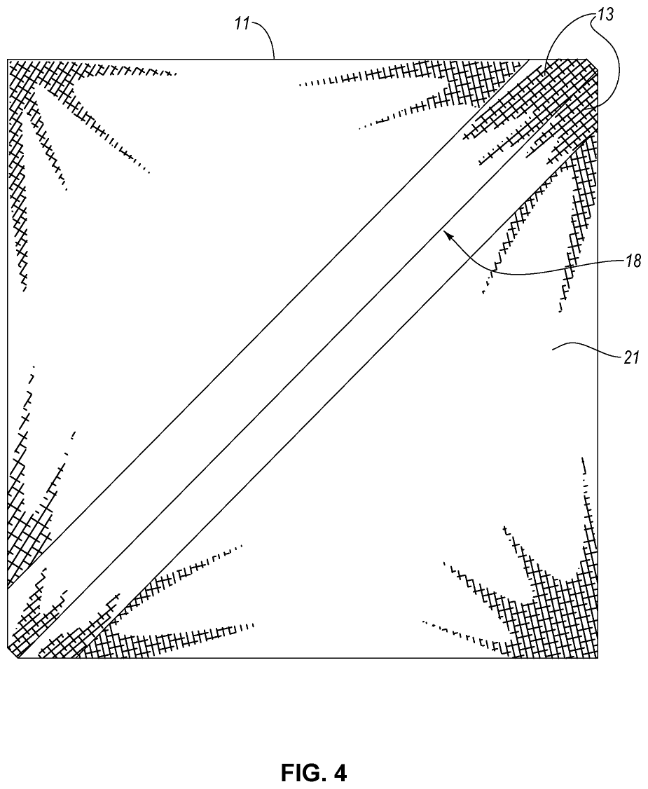

FIGS. 1 and 3 depict two separate triangularly-shaped segments 14 that connect along a diagonal seam 18 to make up a square sheet 11. In one embodiment, the two separate segments 14 connect along the diagonal seam 18 of the square using a releasable connector feature 12. For example, in FIG. 1, low-profile hook-and-loop fasteners are used as the releasable connector feature 12, as the use of a thin, flexible, and long-lasting low-profile hook and loop product maintains the diagonal seam 18 discrete and generally flat along the sheet, making it easier to wrap a gift inside and make the gift look more similar to a gift wrapped in paper. The releasable connecting feature 12 is selected and dimensioned to provide a predetermined separation force sufficient to create progressive resistance during opening, thereby enhancing a simulated tearing experience. The releasable connector feature 12 may be selected or configured to provide a separation resistance sufficient to cooperate with the sensory-feedback feature or layer, to generate a paper or tearing-like audible and tactile feedback during opening.

The sheet 11 includes at least one sensory-feedback feature 13 which can be a sensory-feedback layer. Each of the phrases “sensory-feedback feature” and “sensory-feedback layer” refers to a material or component configured to generate audible, tactile, or combined sensory feedback in response to mechanical manipulation of the reusable gift wrap. In one embodiment, the sensory-feedback feature 13 is positioned adjacent to or in proximity with the releasable connector feature 12, and comprises an internal crinkle material that cooperates with the releasable connector feature 12 as a gift is removed, by opening along the releasable connector feature 12, thereby providing an auditory and tactile experience similar to opening a gift wrapped in paper and allowing repeated opening and reconnection of the sheet 11.

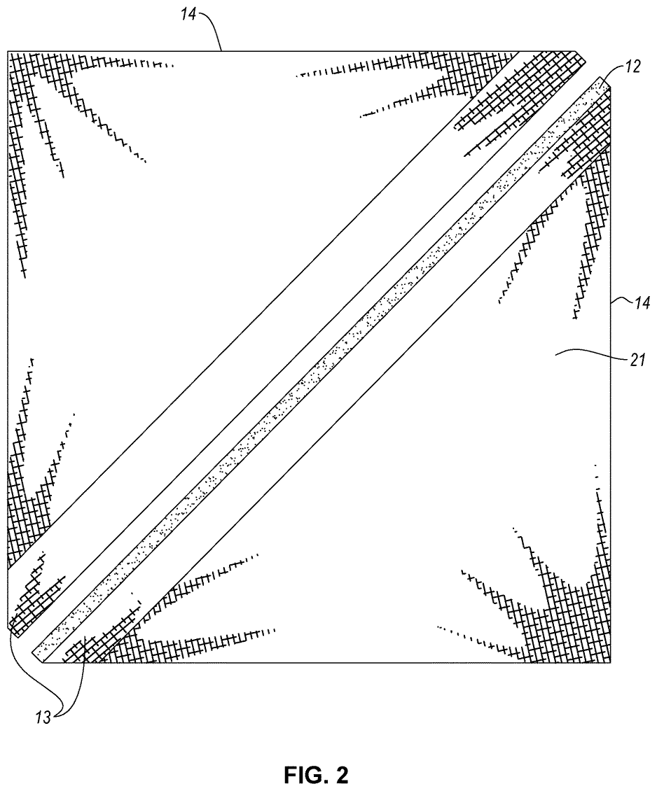

Any material or materials may be used as the sensory-feedback feature 13 corresponding to one or more features or layers, as long as they generate the paper, crinkling, tearing-like, or any other audible sensory feedback similar to opening a gift in paper. FIG. 2 displays two layers of fabric lining on each side of the diagonal seam 18 along the releasable connector feature 12, which purposely creates a pocket to conceal an interior sensory-feedback feature 13. In one embodiment, the sensory-feedback feature 13 is lined only along the diagonal seam 18 of the sheet 11 adjacent to the releasable connector feature 12 because the sensory-feedback feature may be less flexible. This allows the outer area of the sheet 11 to remain pliable, to wrap more tightly and more easily enclose a gift.

In one embodiment, two separate segments 14 connect along the diagonal seam 18 of the sheet 11, so that gifts can be lined up centrally along the diagonal seam 18 on the interior 21 of the sheet 11 to be wrapped inside the sheet 11. When a gift is wrapped inside the sheet 11, the diagonal seam 18 of the sheet 11 creates an opening path 26 along the exterior of the wrapped gift, where the wrapping can be opened and a gift removed at the releasable connector feature 12, as seen in FIG. 8, which is in a comparable location to where a seam may be located when opening a gift wrapped in paper. Opening path 26 locations using releasable connector feature(s) 12 may be added, moved, or removed, depending on the total size and shape of the fabric sheet 11 and the requirements of a pattern.

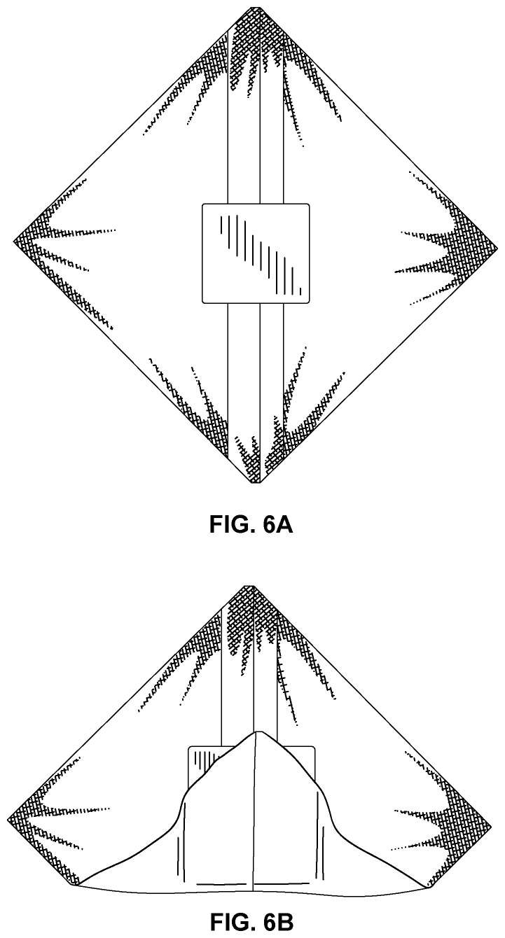

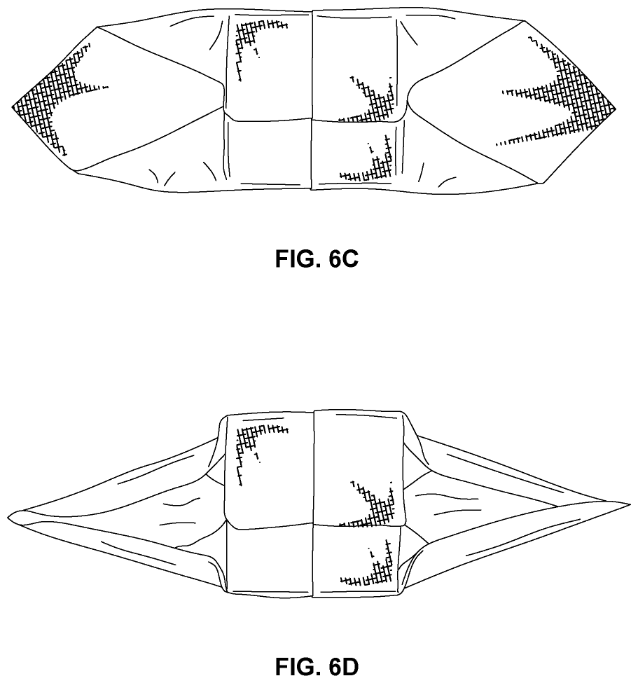

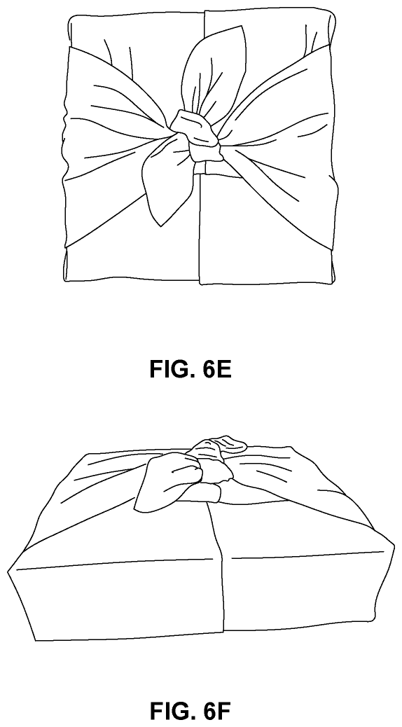

In one embodiment, a gift is positioned along the diagonal seam 18 described above, so the sheet 11 can be folded around the gift in an easily learnable fashion, similar to wrapping a gift in paper as illustrated in FIG. 6A-6F. Fabric is folded and tied to itself, making a knotted bow 19 on the top to fasten and seal the gift. Placing a gift directly over the diagonal seam 18 inside the sheet 11 allows proper placement for the sheet to be opened along the opening path 26, using the releasable connector feature 12 and the gift to be removed, similarly to opening a gift wrapped in paper. The sheet 11 can be used to wrap a gift in any way that enables a gift to be wrapped and opened.

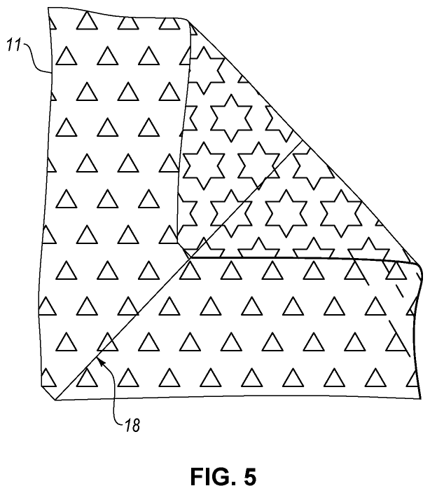

In one embodiment, the sheet 11 is made from fabric material, including but not limited to, cotton, hemp, linen, polyester, silk, rayon, nylon, or other fabric or fabric blends, or any other flexible sheet structures that are opaque enough to conceal a gift, and sufficiently flexible to wrap around it. The sheet 11 can be made of a single layer or multiple layers depending on the requirements of the pattern. Single-layer sheets 11 may be wrapped more tightly around gifts, while double-layer sheets, as seen in FIG. 5, can provide additional structural support or allow for differing prints on each side if desired.

In alternate embodiments, the reusable gift-wrapping system may include a controlled separation interface, defined as a region or mechanism configured to allow the wrapping system to remain closed while enclosing a gift, and configured to permit controlled opening when a gift is removed. The controlled separation interface may be implemented using one or more releasable connector features, structural characteristics of the wrapping pattern, or other structures configured to perform the same or similar controlled separation function. In some embodiments, the controlled separation interface may include one or more releasable connector features 12. Various types of fasteners, components, or systems may be used as the releasable connector feature, including but not limited to, hook-and-loop fasteners, magnetic elements, snaps, or other systems designed into a pattern that allow a sheet 11 to be held together and opened in a manner similar to opening a gift wrapped in paper. Such systems provide a degree of separation resistance, while allowing the sheet to be repeatedly opened and reused in a manner consistent with the intended wrapping function and may or may not contribute to audible feedback.

In other embodiments, the controlled separation interface may be formed by structural characteristics of the wrapping pattern, including interlocking panels, tension-retaining folds, or any other configurations that allow the sheet to remain closed while permitting controlled opening along an opening path 26 for gift removal. More than one controlled separation interface may be used in combination, such as a tension-retaining fold along an opening path 26 with a hook-and-loop fastener. The foregoing examples are provided for illustrative purposes only, and other fastening systems capable of providing releasable attachment and controlled separation of the sheet may be used without departing from the scope of the invention.

Although certain embodiments position the sensory-feedback feature 13 between or within layers along a seam, the sensory-feedback feature or layer may also be placed elsewhere in one or more locations on the interior or exterior of the sheet 11, and may comprise any one or more materials selected with one or more layers to produce the desired audible sound when stressed, moved, or manipulated, as long as there is no restriction on wrapping a gift and the one or more sensory-feedback features or layers remain reusable and continue to provide audible crinkling, paper-like and tearing-like feedback, or other similar auditory feedback when gifts are opened. Further, it shall be appreciated that embodiments of the wrap apparatus and system may comprise each sensory feedback feature or layer arranged as a single layer, or alternatively multiple sensory feedback features and/or layers stacked and secured together.

The sensory-feedback feature 13 may be formed from any material or combination of materials capable of producing audible or tactile feedback when flexed, compressed, manipulated or deformed, during gift opening of the controlled separation interface(s). Suitable materials may include, but are not limited to, crinkle material, biodegradable films, polymer films, laminated films, coated textiles, nonwoven materials, or other deformable sheet materials. The sensory-feedback feature or layer may be embedded, laminated, loosely positioned, partially attached along edges, integrated within seams, resized, or otherwise arranged within a pattern. It should be understood that embodiments of the invention are not limited to the specific materials listed herein, and that other materials capable of producing comparable sensory feedback may be substituted without departing from the scope of the invention.

In alternate embodiments, the sensory-feedback feature or layer may be positioned adjacent to, in proximity with, or otherwise arranged to interact with the releasable connector feature 12 or any other controlled separation interface methods, so that mechanical manipulation of the sheet during gift opening produces audible or tactile feedback similar to the experience of opening a gift wrapped in paper.

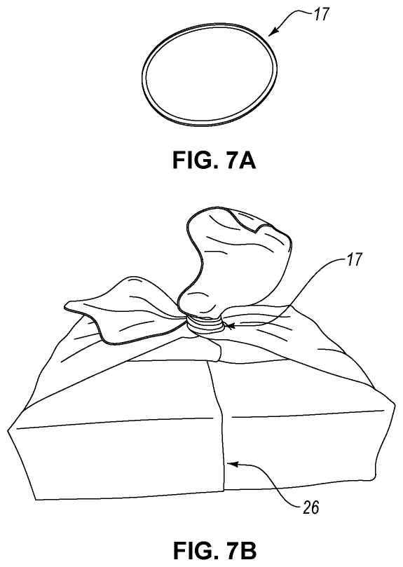

In one embodiment, gifts can be aligned along the diagonal seam 18 of the sheet 11 to be wrapped inside, and are fastened by tying the sheet 11 to itself. Other embodiments may provide alternate methods of fastening a gift inside a sheet 11, including but not limited to, using a separate tie, elastic band 17, as seen in FIGS. 7A and 7B, or other separate fastening feature(s). The ends may be arranged, tucked, or formed into a decorative bow, or otherwise secured in any manner that maintains the gift neatly wrapped. Fastening features can be integrated into the pattern of a sheet 11 or otherwise designed to enclose a gift in the sheet, while allowing controlled opening of a gift along an opening path 26. Any method or a combination of methods can be used to fasten a gift inside the sheet 11 if the gift can be neatly wrapped, and there remains an opening experience similar to opening a gift wrapped in paper.

In other embodiments, the sheet 11 may be a single-piece design that incorporates one or more controlled separation interface(s) without connecting segments. The sheet may include structural patterns, folds, overlapping regions, or other features that help maintain the wrapped configuration and create resistance during opening, thereby reproducing an opening experience like opening a gift wrapped in paper while remaining reusable. The controlled separation interface(s) may be formed through but not limited to connector features, such as hook-and-loop fasteners, snaps, magnetic elements, other fastening systems, or through structural features of the sheet alone or a combination of methods. Fastening a gift inside the sheet may be performed in a similar manner to a multi-segment version, using ties or knots securing the sheet to itself, pattern-integrated or attachable fasteners, or any other fastening method or combination of fastening methods which allow a gift to be neatly wrapped while providing a controlled opening experience through an opening path 26. Such alternate embodiments may optionally include one or more sensory-feedback features or layers which are intended to provide a similar interactive experience described for segment-based designs. All such configurations are included within the scope of the invention.

In alternate embodiments, the sheet 11 may be formed from any material or sheet structure that is flexible enough to wrap around a gift, including fabrics with or without stretch, laminated materials, composite sheet materials, or other flexible sheet structures, while maintaining the reusable functionality of the wrapping system/apparatus and ability to conceal a gift inside.

Although previously described embodiments include a diagonal seam 18, alternate embodiments may incorporate one or more seams of different orientations, geometries, or positions within the sheet 11. In some embodiments, the seam(s) may function as a controlled separation interface that permits controlled opening of the wrapped gift in a manner similar to opening a gift wrapped in paper. In other embodiments, the controlled separation interface may be formed through structural characteristics of the sheet 11 without a defined seam.

Decorative elements such as but not limited to tassels, ribbons, charms, pins, magnets, beads, labels, or other gift labeling features may be attached to a nonelastic or elastic band 17 that is adhered to a gift, incorporated into a tied bow 19 of a wrapped gift, or attached directly to the sheet 11 or by any other methods that allow the elements to remain with a gift.

Alternate embodiments of the invention may include an opening feature, such as one or more pull or opening tab(s) 27 positioned along a releasable connector feature 12 or other controlled separation interface method specifically placed to indicate an opening location. This allows a user to ease the initial opening of a wrapped gift along an opening path 26 as seen in FIG. 10. The opening tab 27 may also function as an indicator showing where segments can be aligned and reconnected for future reuse.

In alternate embodiments, the reusable wrapping system may function without the inclusion of a sensory-feedback feature or layer. In such embodiments, the releasable connector feature or other controlled separation interface may still allow the sheet 11 to be opened through pulling or applied tension in a manner like opening a gift wrapped in paper, while allowing the sheet to be reassembled or otherwise arranged for reuse.

Alternate embodiments may include a single-piece or multi-segment wrapping structure, with or without one or more sensory-feedback features and/or layers, that are held together by one or more releasable connector features, structural characteristics of a pattern, or other structures to perform the controlled separation function. The single-piece or multi-segment wrapping structure can be arranged to form the shape of a gift bag or sack that a gift can be placed and concealed inside without wrapping. The wrapping structure may include one or more integrated opening paths 26 along the bag structure that can be actively pulled open to reveal a gift inside. The wrapping structure can be arranged in any size or shape depending on the needs of a pattern, and can be reassembled or rearranged for repeated use. The bag or sack wrapping structure creates a more convenient gift-wrapping experience that still delivers a reusable sensory interactive gift opening experience, but does not require a gift to be wrapped using traditional steps, as seen in other previously described embodiments.

In alternate embodiments, one or more components of the reusable gift-wrapping system/apparatus, including the releasable connector feature or other controlled separation interface methods and the sensory-feedback feature(s) and/or layer(s), may be modified, replaced, or rearranged including through the use of alternate components, materials, systems, structural design, or configurations that preserve their coordinated function to deliver a sensory-gift opening experience comparable to opening a gift in paper. The sheet or segments may include variations in size, proportion, folding patterns, segmentation, reinforcement, connector type, fastening strength, layering, material composition, placement, or other structural features, including but not limited to those described herein, provided that the wrapping system remains reusable and continues to produce the audible and tactile experience associated with opening a gift. All such embodiments, whether single-piece, segmented, or hybrid, and whether or not they include any sensory-feedback feature(s) and/or layer(s), are intended to produce the same interactive experience of opening a gift while allowing repeated use.

Opening paths 26 may occur along, adjacent to, or in proximity to seams, releasable connector features, or other controlled separation interfaces. The orientation, direction, or arrangement of segments, seams, releasable connector features, or controlled separation interfaces may be reversed, mirrored, rotated, or otherwise rearranged without departing from the scope of the invention.

The embodiments described herein are provided for illustrative purposes only. The invention may be implemented in various combinations of sheets, segments, openings, connector features, folds, materials, or other structural arrangements that achieve the described controlled opening, reusability, and sensory-feedback functions. Variations in structure, materials, configuration, and arrangement of components may be made without departing from the spirit and scope of the invention.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results.

What is claimed is:

1. A reusable wrap apparatus for use to enclose an object and provide a sensory experience to a user in response to mechanical manipulation of the apparatus relative to the object, the wrap apparatus comprising:
a pliable sheet configured to receive and enclose the object in an enclosed state;
a releasable connector detachably coupled to the sheet, and configured to attach to a portion of the sheet around the object in the enclosed state, and to detach from the portion of the sheet in an opened state to permit removal of the object from the sheet; and
a sensory feedback feature coupled to the sheet and configured to provide an audible feedback or tactile feedback to the user, in response to mechanical manipulation of the sheet or detachment of the releasable connector from the portion of the sheet during a release from the enclosed state.

2. The wrap apparatus of claim 1, wherein
the pliable sheet is formed by a pair of segments with a corresponding pair of edges that is detachably coupled together along a seam, and
the releasable connector extends along at least one of the corresponding pair of edges of the pair of segments.

3. The wrap apparatus of claim 2, wherein
the segments of the pliable sheet are triangularly shaped and the seam extends diagonally along the sheet.

4. The wrap apparatus of claim 3, wherein the segments of the pliable sheet comprise a same size.

5. The wrap apparatus of claim 2, wherein the sensory feedback feature is a sensory feedback layer.

6. The wrap apparatus of claim 2, wherein
the sensory feedback feature comprises a pair of sensory feedback layers that is coupled to the corresponding pair of segments and extends along the seam of the pliable sheet, and
each of the pair of sensory feedback layers is positioned adjacent to or in proximity to the releasable connector.

7. The wrap apparatus of claim 6, wherein each of the pair of segments comprises a pocket to store the corresponding one of the pair of sensory feedback layers.

8. The wrap apparatus of claim 6, wherein each of the sensory feedback layers is a material that crinkles and generates the audible feedback in response to the mechanical manipulation of the sheet or detachment of the releasable connector from the portion of the sheet.

9. The wrap apparatus of claim 2, wherein the releasable connector is a fastener selected from a group consisting of hook-and-loop fasteners, magnetic components, snap components and interlocking panels.

10. The wrap apparatus of claim 1, further comprising a band disposed around the pliable sheet to secure the sheet in the enclosed state.

11. The wrap apparatus of claim 1, further comprising a tab coupled to the sheet and positioned adjacent to the releasable connector.
